(19) United States
(12) Patent Application Publication
(10) Pub. No.: US 2026/0234514 A1
(43) Pub. Date: Aug. 13, 2026

(54) COMPOSITION FOR THE REMOVAL OF STAINS

(71) Applicant: Reckitt Benckiser Vanish B.V., Hoofddorp (NL)

(72) Inventors: Fabiola BIROLO, Mira (IT); Giorgio CONTON, Mira (IT); Riccardo DORO, Mira (IT); Mattia GIRARDINI, Heidelberg (DE); Sara QUAGGIA, Mira (IT); Elisa SCOMPARIN, Mira (IT); Luca SPADONI, Mira (IT)

(21) Appl. No.: 19/118,571

(22) PCT Filed: Oct. 20, 2023
(86) PCT No.: PCT/EP2023/079360

§ 371 Date: Apr. 4, 2025

(30) Foreign Application Priority Data
Oct. 20, 2022 (GB) 2215478.5

(51) Int. Cl. C11D 17/06; C11D 1/00; C11D 3/04; C11D 3/10; C11D 3/386; C11D 3/39

(52) U.S. Cl. CPC C11D 17/06; C11D 1/00; C11D 3/046; C11D 3/10; C11D 3/38609; C11D 3/38627; C11D 3/38645; C11D 3/391; C11D 3/3917; C11D 3/3932; C11D 2111/12

(57) ABSTRACT

The present invention relates to a composition, preferably a laundry detergent composition or a laundry additive composition, comprising between 22 wt. % and 30 wt. % of at least one bleaching agent, based on the total weight of the composition, between 0.001 wt. % and 2 wt. % of at least one oxygen transfer agent, based on the total weight of the composition, wherein said at last one oxygen transfer agent is selected from the group comprising 3-methyl-1,2-benzisothiazol-1,1-dioxide, 1,2,3-Benzoxathiazine, 2,2-dioxide, and combinations thereof; and between 0.001 wt. % and 1 wt. % of at least one lipase, based on the total weight of the composition. The invention further relates to a method of a laundering a fabric in a laundry washing machine. It also relates to the use of the composition for the removal of greasy or oil-based stains and malodour removal.

The present invention relates to a composition, for example a laundry detergent or a laundry additive, to a method of laundering a fabric in a laundry washing machine, to a method of cleaning a stain on a laundry item, and to the use of the composition for the removal of stains and/or the removal of malodour from a garment.

### BACKGROUND

Consumers associate desirability and wearability of a garment with characteristics such as e.g., whiteness, freshness, and/or absence of stains. It is preferred when both characteristics are achieved in a simple way.

The removal of stains is achieved using bleaching agents, surfactants and/or enzymes. For example, enzymatic stains require enzymes, oil-based or greasy stains require enzymes or a combination of surfactants, bleachable stains require a bleaching agent to remove them.

When considering greasy or oil-based stains, to improve the performance of a stain-removal formulation, the amounts of surfactants or enzymes is normally increased. This is not environmentally friendly and can be prohibitive from a costs point of view.

Clothing is also where germs and bacteria can grow, allowing the formation of malodour. Often laundry detergents and fragrance boosters try to overcome this issue by introducing a substantial amount of scent, for example in the form of microcapsules, that covers the undesired smells. However, once the volatile fragrance molecules leave the fabric, the unpleasant malodour will still be present, or can rebloom, over time or upon ironing.

Regular laundry compositions are useful for cleaning clothes, meaning that grime and dirt are removed. However, for the removal of stains or malodour, and in the case of white garments, improved whiteness, additional laundry compositions are needed.

Normally, people are required to follow long cleaning procedures, involving pre-treatment, vigorous rubbing action, or washings at high temperatures to achieve acceptable stain and malodour removal. For example, washing operations are normally performed at temperatures between 40° C. and 60° C.

Patent application WO2022/069468 A1 to Reckitt Benckiser Vanish B.V. describes compositions comprising a bleaching agent, at least one oxygen transfer agent, and a protease. The compositions disclosed in this document have a high content of the bleaching agent and are intended mainly for the removal of turmeric and/or curry stains.

Patent application EP 0446982 to Unilever NV describes a bleaching composition comprising small amounts of sulfonimines. According to this document, sulfonimines can boost the performance of bleach precursor-peroxygen compound systems. However, this document does not disclose compositions for the removal of grease or oil-based stains.

Hence, there is a need of a composition, preferably a laundry detergent composition or a laundry additive composition, which provides removal of stains, in particular greasy or oil-based stains, preferably whilst providing the removal of malodour of a garment being washed with such composition.

It is an object of the present invention to provide a composition, preferably a laundry detergent composition or a laundry additive, which provides a solution for these needs; in particular, when a garment is washed with the composition at temperatures lower than those normally used in washing operations.

It is an object of the present invention to provide a method of laundering a fabric in a laundry washing machine.

It is an object of the present invention to provide a use of a composition for the removal of greasy or oil-based stains from a garment, and/or the removal of malodour from a garment.

### SUMMARY OF THE INVENTION

In a first aspect, the present invention relates to a composition comprising:
between 22 wt. % and 30 wt. % of at least one bleaching agent, based on the total weight of the composition,
between 0.001 wt. % and 2 wt. % of at least one oxygen transfer agent, based on the total weight of the composition, wherein said at last one oxygen transfer agent is selected from the group comprising 3-methyl-1,2-benzisothiazol-1,1-dioxide, 1,2,3-Benzoxathiazine, 2,2-dioxide, and combinations thereof, and
between 0.001 wt. % and 1 wt. % of at least one lipase, based on the total weight of the composition.

In one embodiment, said composition comprises:
between 25 wt. % and 30 wt. % of said at least one bleaching agent, based on the total weight of the composition, preferably between 27 wt. % and 30 wt. %, more preferably between 28 wt. % and 30 wt. %; and
between 0.005 wt. % and 1.5 wt. % of said at least one oxygen transfer agent, based on the total weight of the composition, preferably between 0.01 wt. % and 1.00 wt. %, more preferably between 0.025 and 0.75 wt. %.

In another embodiment, said at least one bleaching agent comprises at least one source of active oxygen selected from the group comprising an inorganic peroxide, an inorganic peroxide, an organic peracid, and combinations thereof; preferably selected from the group comprising hydrogen peroxide, sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

In an embodiment, said composition comprises between 0.1 wt. % and 20 wt. % of said at least one bleach activator, based on the total weight of the composition, preferably between 0.25 wt. % and 15 wt. %, more preferably between 0.5 wt. % and 10 wt. %, most preferably between 1 wt. % and 5 wt. %.

In another embodiment, said at least one bleach activator is selected from the group consisting of tetraacetylethylendiamine (TAED), acetylated triazine derivatives, acetylated glycoluriles, acylimides, acetylated phenolsulfonates, acetylated phenol carbonic acids, carbonic acid anhydrides, acetylated sugar derivatives, N-acetylated lactams, and combinations thereof; preferably said at least one bleach activator comprises or consists of tetraacetylethylendiamine (TAED).

In a preferred embodiment, said at least one oxygen transfer agent comprises or consists of 3-methyl-1,2-benzisothiazol-1,1-dioxide.

In an embodiment, said composition further between 0.0001 wt. % and 10 wt. % of one or more further enzymes, based on the total weight of the composition, preferably between 0.0005 wt. % and 5 wt. %, more preferably between 0.001 wt. % and 2.5 wt. %, even more preferably between 0.001 wt. % and 2 wt. %, most preferably between 0.001 wt. % and 1 wt. %; wherein said one or more further enzymes are selected from the group consisting of a mannanase, an amylase, a cellulase, a protease, and combinations thereof, preferably wherein said one or more further enzymes are selected from the group consisting of an amylase, a cellulase, a protease, and combinations thereof.

In another embodiment, said composition is a laundry detergent composition or a laundry additive composition.

In another embodiment, the pH at 20° C. of a dilution of 1:100 of the composition is between 9 and 12, preferably between 9.5 and 11.5, more preferably between 10 and 11.

In an embodiment, the composition is inf the form of a solid or a powder.

In a second aspect, the invention relates to a method of laundering a fabric in a laundry washing machine comprising adding a composition according to the first aspect to the washing machine and conducting the wash, wherein preferably the wash liquor is at a temperature lower than 40°, more preferably lower than 30° C., even more preferably lower than 25° C., most preferably lower than 20° C.; and wherein preferably between 0.5 g and 10 g of the composition are added to the laundry washing machine per litre of washing liquor, more preferably between 1 g and 5 g.

In a third aspect, the invention relates to a method of cleaning a stain on a laundry item comprising:
mixing the composition according to the first aspect with water and contacting the stain directly with the obtained mixture before the laundry item is washed, or
adding the composition according to the first aspect directly into the drum of washing machine, or
adding the composition according to the first aspect to a bucket with water and soaking for a predetermined length of time.

In a fourth aspect, the invention relates to a use of the composition according to the first aspect in a laundry washing and/or fabric treatment operation.

In a fifth aspect, the invention relates to a use of the composition according to the first aspect for the removal of greasy or oil-based stains and/or the removal of malodour from a garment.

In an embodiment of the fifth aspect, the garment is made of cotton, synthetic materials or a combination thereof, preferably said synthetic material is polyester.

### Definitions

The following definitions are used in the present application.

“Ganz value/Instrumental evaluation” as used in the present application means: whiteness degree simulated as Ganz-Griesser value as specified in the A.I.S.E. Laundry detergent testing guidelines.

“Protease” as used in the present application means: class of enzymes that catalyse the breakdown of proteins into smaller polypeptides or single amino acids.

“Amylase” as used in the present application means: class of enzymes that catalyse the hydrolysis of starch into sugars such as glucose and maltose.

“Mannanase” as used in the present application means: class of enzymes that catalyse the hydrolysis of mannose derivatives.

“Mannose” as used in the present application means: sugar monomer of the aldohexose series of carbohydrates.

“Lipase” as used in the present application means: class of enzymes that catalyse the hydrolysis of fats or lipids.

“Cellulase” as used in the present application means: class of enzymes that catalyse the cellulolysis or hydrolysis of cellulose.

“Laundry detergent composition” as used in the present application means: composition used primarily for the cleaning of garments and whose main action is the removal of grime and dirt, comprising a builder and not having lipases.

“Laundry additive composition” as used in the present application means: composition which is used for providing a specific consumer benefit, such as: removal of stains, elimination of malodour, improvement of whiteness and/or disinfection of garments. This means that the mean action of a laundry additive is not the removal or grime and dirt. Furthermore, a laundry additive is commonly used as a pre-treatment, in soaking conditions or together with a laundry detergent composition.

“Poly-cotton or Polycotton” as used in the present application means: fabric made of a blend of cotton and polyester. For example, the blend can have between 65 wt. % and 80 wt. % of polyester and between 20 wt. % and 35 wt. % of cotton.

### DETAILED DESCRIPTION OF THE INVENTION

In a first aspect, the present invention relates to a composition comprising:
between 22 wt. % and 30 wt. % of at least one bleaching agent, based on the total weight of the composition,
between 0.001 wt. % and 2 wt. % of at least one oxygen transfer agent, based on the total weight of the composition, wherein said at last one oxygen transfer agent is selected from the group comprising 3-methyl-1,2-benzisothiazol-1,1-dioxide, 1,2,3-Benzoxathiazine, 2,2-dioxide, and combinations thereof, and
between 0.001 wt. % and 1 wt. % of at least one lipase, based on the total weight of the composition.

The present inventors have observed that the detergent compositions according to the invention provide a better removal of greasy or oil-based stains than compositions not containing an oxygen transfer agent selected from the group comprising 3-methyl-1,2-benzisothiazol-1,1-dioxide, 1,2,3-Benzoxathiazine, 2,2-dioxide, and combinations thereof and at least one lipase.

These oxygen transfer agents react in the washing liquor to produce oxaziridines, which are responsible for the improved stain removal.

Furthermore, the compositions according to the invention allow for the combined effect of removal of greasy or oil-based stains and malodour, even at temperatures lower than those usually used in automatic laundry washing (e.g., 30° C. or 40° C.). It is believed that by adding the oxygen transfer agent to a detergent composition comprising a bleaching agent a bleach activator, and a lipase the activation energy needed to remove a stain is reduced; this means that, the compositions according to the invention allow for the removal of stains from the fabric at lower temperatures, for example, 15° C., and faster than a composition not containing the oxygen transfer agent and the at least one lipase.

An effect that would be obtained with the composition according to the invention, in particular in garments made of polyester, is improvement of whites or whitening. As previously discussed, the oxygen transfer agents in the compositions according to the invention produce oxaziridines, which have a hydrophobic nature and can interact with polyethylene terephthalate in polyesters textiles. This interaction allows for a better whitening of the textiles.

Preferably, said at least one oxygen transfer agent comprises or consists of 3-methyl-1,2-benzisothiazol-1,1-dioxide.

The composition may comprise:
between 25 wt. % and 30 wt. % of said at least one bleaching agent, based on the total weight of the composition, preferably between 27 wt. % and 30 wt. %, more preferably between 28 wt. % and 30 wt. %; and
between 0.005 wt. % and 1.5 wt. % of said at least one oxygen transfer agent, based on the total weight of the composition, preferably between 0.01 wt. % and 1.00 wt. %, more preferably between 0.025 and 0.75 wt. %.

In a preferred embodiment the composition comprises between 22 wt. % and 30 wt. % of said at least one bleaching agent, between 0.001 wt. % and 1 wt. % of said at least one lipase, and between 0.025 wt. % and 0.75 wt. % of said at least one oxygen transfer agent, based on the total weight of the composition.

The present inventors have observed that by combining the oxygen transfer agent and the lipase in the compositions according to the invention, it is possible to use lower amounts of bleaching agent. For example, in stain removals the content of bleaching agent is normally between 35 wt. % and 50 wt. %. However, if the oxygen transfer agent and at least one lipase are added to a composition, it is possible to obtain excellent stain removal, in particular of greasy stains, with lower amounts of bleaching agent, e.g. with about 30 wt. % of bleaching agent.

The bleaching agent is preferably selected from the group consisting of an oxygen-releasing bleaching agent, a chlorine-releasing bleaching agent and combinations of two or more thereof. The at least one bleaching agent may then comprise at least one source of active oxygen selected from the group comprising an inorganic peroxide, an organic peracid, and combinations thereof; preferably selected from the group comprising hydrogen peroxide, sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

The at least one bleach activator is preferably selected from the group consisting of tetraacetylethylendiamine (TAED), acetylated triazine derivatives, acetylated glycoluriles, acylimides, acetylated phenolsulfonates, acetylated phenol carbonic acids, carbonic acid anhydrides, acetylated sugar derivatives, N-acetylated lactams, and combinations thereof; preferably said at least one bleach activator comprises or consists of tetraacetylethylendiamine (TAED).

The composition may comprise between 0.1 wt. % and 20 wt. % of said at least one bleach activator, based on the total weight of the composition, preferably between 0.25 wt. % and 15 wt. %, more preferably between 0.5 wt. % and 10 wt. %, most preferably between 1 wt. % and 5 wt. %.

The composition according to the invention comprising at last one oxygen transfer agent and at least one lipase allows for the incorporation of more enzymes, which have a synergistic effect with the other elements of the composition. For example, the composition may further comprise between 0.0001 wt. % and 10 wt. % of one or more further enzymes, based on the total weight of the composition, preferably between 0.0005 wt. % and 5 wt. %, more preferably between 0.001 wt. % and 2.5 wt. %, even more preferably between 0.001 wt. % and 2 wt. %, most preferably between 0.001 wt. % and 1 wt. %; wherein said one or more further enzymes are selected from the group consisting of a mannanase, an amylase, a cellulase, a protease, and combinations thereof, preferably wherein said one or more further enzymes are selected from the group consisting of an amylase, a cellulase, a protease, and combinations thereof.

The compositions of the present invention may take any form, e.g. solid, liquid, gel, powder or mixtures thereof. Preferably, the compositions will be in form of a solid or a powder.

The composition is preferably a laundry detergent composition or a laundry additive composition, more preferably the composition is a laundry additive composition.

Preferably, the pH at 20° C. of a dilution of 1:100 of the composition is between 9 and 12, more preferably between 9.5 and 11.5, even more preferably between 10 and 11.

Preferably the composition further comprises a rheology modifier agent, a fragrance, a phase stabilizer, a dye, a softening agent, a chelating agent, an anti-bacterial agent, a transition metal compound, an anti-foaming agent, a preservative, one or more surfactants, one or more fillers, a dye-transfer inhibitor, an optical brightener, or combinations thereof.

The composition may comprise one or more non-ionic surfactants. The amount of said one or more non-ionic surfactants in the composition may be between 0.01 wt. % and 10 wt. %, based on the total weight of the composition, preferably between 0.05 and 5 wt. %, more preferably between 0.1 and 1.0 wt. %. Examples of non-ionic surfactants are ethoxylated alcohols and ethoxylated alkyl phenols having the formula R¹(OCH₂CH₂)ₙOH; wherein R¹ is an aliphatic hydrocarbon radicals containing between 10 and 24 carbon atoms or alkyl phenyl radicals in which the alkyl groups contain from 10 to 22 carbon atoms; and n has an average value of from 1 to 10. Preferably, the one or more non-ionic surfactants have the formula R¹(OCH₂CH₂)ₙOH; wherein R¹ is an alkyl moiety having between 10 and 24 carbon atoms, and n has an average value of from 1 to 10.

For example, when R¹ is defined as being a C₁₂₋₁₄ moiety, it is meant an alkyl moiety having between 12 and 14 carbon atoms. For example, when R¹ is defined as being a C₁₂₋₁₆ moiety, it is meant an alkyl moiety having between 12 and 16 carbon atoms. For example, when R¹ is defined as being a C₁₃ moiety, it is meant an alkyl moiety having 13 carbon atoms.

In a preferred embodiment, the composition comprises between 0.01 wt. % and 10 wt. % of one or more non-ionic surfactants, based on the total weight of the composition, preferably between 0.05 and 5 wt. %, more preferably between 0.1 and 1.0 wt. %; wherein said one or more non-ionic surfactants have the formula R¹(OCH₂CH₂)ₙOH; wherein R¹ is an alkyl moiety having between 12 and 16 carbon atoms, and n has an average value of from 3 to 6, preferably between 4 and 5.

The composition may further comprise any conventional anionic surfactant or a mixture of them used in detergent products. These include, for example, the alkyl benzene sulfonic acids and their salts as well as alkoxylated or non-alkoxylated alkyl sulfate materials. The anionic surfactants may be present in acid form or in neutralized (e.g., salt) form. The anionic surfactants may be linear, branched, or a mixture thereof. An example of an anionic surfactant is sodium cumenesulphonate.

Examples of anionic surfactants are the alkali metal salts of C₁₀₋₁₆ alkyl benzene sulphonic acids or C₁₁₋₁₄ alkyl benzene sulphonic acids.

Another exemplary type of anionic surfactant is alkoxylated alkyl sulphate surfactants, such as ethoxylated alkyl sulphate surfactants. Such materials are also known as alkyl ether sulphates or alkyl polyethoxylate sulphates.

Alkyl ether sulphates are generally available in the form of mixtures comprising varying R′ chain lengths and varying degrees of ethoxylation. Frequently such mixtures also contain some non-ethoxylated alkyl sulphate (“AS”) materials.

In a preferred embodiment, the composition comprises:
between 0.01 wt. % and 10 wt. % of one or more non-ionic surfactants, based on the total weight of the composition, preferably between 0.05 and 5 wt. %, more preferably between 0.1 and 1.0 wt. %; wherein said one or more non-ionic surfactants have the formula R¹(OCH₂CH₂)ₙOH; wherein R¹ is an alkyl moiety having between 12 and 16 carbon atoms, and n has an average value of from 3 to 6, preferably between 4 and 5; and
between 0.01 wt. % and 10 wt. % of one or more anionic surfactants, based on the total weight of the composition, preferably between 0.05 and 7.5 wt. %, more preferably between 0.1 and 5 wt. %; wherein said one or more anionic surfactants preferably comprise a sodium salt of linear alkyl benzene sulfonate, sodium xylene sulfonate, an alcohol sulphate, an alfa olefin sulfonate, or combinations thereof.

The selection of non-ionic surfactants and anionic surfactants, in, for example, this preferred embodiment, is important for the compatibility of the composition with the high amounts of the bleaching agent, but also for controlling the foaming, detergency, flowability, and other physical and chemical properties of the composition.

The composition may optionally contain a filler. Suitable fillers include bicarbonates and carbonates of metals, such as alkali metals and alkaline earth metals. Examples include sodium carbonate, sodium bicarbonate, calcium carbonate, calcium bicarbonate, magnesium carbonate, magnesium bicarbonate and sesqui-carbonates of sodium, calcium and/or magnesium. Other examples include metal carboxy glycine and metal glycine carbonate. Chlorides, such as sodium chloride; citrates; and sulfates, such as sodium sulfate, calcium sulfate and magnesium sulfate, may also be employed. Preferably the composition comprises at least one filler selected from the group comprising alkyl carbonate, alkyl sulfate and combinations thereof; more preferably selected from the group comprising sodium carbonate, sodium sulfate and combinations thereof.

When a filler is present, the composition may comprise between 0.1 wt. % and 80 wt. % of said at least one filler, based on the total weight of the composition, preferably between 10 wt. % and 75 wt. %, more preferably between 20 wt. % and 70 wt. %.

The composition may comprise an optical brightener, preferably selected from the group comprising stilbene, benzidine, benzothiazole, benzimidazole, benzoxazole, coumarin, pyrazoline, naphtalimide, naphtoxazole, distyryl-biphenyl, benzonitrile, benzopyrazole, including their derivatives and substituted compounds, and combinations thereof. Suitable optical brighteners include 4,4′-bis(2-sulphostyryl)diphenyl, 7-Diethylamino-4-methylcoumarin, benzoxazole, 2,2′-(1,2-ethenediyl)bis [5-methyl] including their substituted compounds, 4,4′-bis(triazine-2ylamino) stilbene-2,2′-disulphonic acid, mono(azol-2-yl) stilbene and bis(azol-2yl) stilbene; styryl derivatives of benzene and biphenyl, such as 1,4-bis(styryl)benzene, 4,4′-bis(styryl)benzene, 4,4′-bis-(styryl) biphenyl, 4,4′-bis(sulphostryryl) biphenyl sodium salt; pyrazolines such as 1, 3-diphenyl-2-pyrazoline; bis(benzene-2-yl) derivatives, bis(benzoxazol-2-yl) derivatives and bis(benzimidazol-2-yl) derivatives; 2-(benzofuran-2-yl)benzimidazole; coumarins such as 4-methyl-7-hydroxy-coumarin or 4-methyl-7-diethylaminocoumarin; carbostyrils; naphthalimides; dibenzothiophene5,5-dioxide; pyrene; or pyridotriazole derivatives and combinations thereof.

When an optical brightener is present, the composition may comprise between 0.001 wt. % and 1 wt. % of at least one optical brightener, based on the total weight of the composition, preferably between 0.01 wt. % and 0.5 wt. %, more preferably between 0.05 wt. % and 0.25 wt. %.

The composition may further comprise a dye-transfer inhibitor. Preferred dye-transfer inhibitors (sometimes called dye anti-redisposition agents or soil suspending agents) include polyvinylalcohol, fatty amides, sodium carboxylmethyl cellulose, hydroxypropyl methyl cellulose, polyvinylpyrollidone, polyvinylimidazole, polyvinyloxazolidone, polyamine N-oxide polymers and copolymers or N-vinylpyrollidone and N-vinylimidazole.

When a dye-transfer inhibitor is present, the composition may comprise between 0.001 wt. % and 1 wt. % of at least one dye transfer inhibitor, based on the total weight of the composition, preferably between 0.01 wt. % and 0.75 wt. %, more preferably between 0.05 wt. % and 0.50 wt. %.

In a preferred embodiment, the composition is a laundry detergent composition or a laundry additive composition in form of a solid or a powder; which comprises:
between 25 wt. % and 30 wt. % of at least one bleaching agent, preferably comprising or consisting of sodium percarbonate;
between 0.025 wt. % and 0.75 wt. % of at least one oxygen transfer agent, preferably comprising or consisting of 3-methyl-1,2-benzisothiazol-1,1-dioxide;
between 0.001 wt. % and 1 wt. % of at least one lipase;
between 1 wt. % and 5 wt. % of at least one bleach activator, preferably comprising or consisting of tetraacetylethylendiamine (TAED); and
preferably further comprising between 0.001 wt. % and 1 wt. % or one or more further enzymes, preferably selected from the group consisting of an amylase, a cellulase, a protease, and combinations thereof;
based on the total weight of the composition.

The composition according to the invention can be prepared by methods known by the person skilled in the art.

In a second aspect, the invention relates to a method of laundering a fabric in a laundry washing machine comprising adding a composition according to the first aspect to the washing machine and conducting the wash, wherein preferably the wash liquor is at a temperature lower than 40°, more preferably lower than 30° C., even more preferably lower than 25° C., most preferably lower than 20° C.; and wherein preferably between 0.5 g and 10 g of the composition are added to the laundry washing machine per litre of washing liquor, more preferably between 1 g and 5 g.

In a third aspect, the invention relates to a method of cleaning a stain on a laundry item comprising:
mixing the composition according to the first aspect with water and contacting the stain directly with the obtained mixture before the laundry item is washed, or
adding the composition according to the first aspect directly into the drum of washing machine, or
adding the composition according to the first aspect to a bucket with water and soaking for a predetermined length of time.

When the composition is added into the drum of the washing machine or when it is added to a bucket with water, the washing liquor may have between 0.5 g and 20 g of the composition by litre of washing liquor. For example, if the composition is added into the drum of the washing machine, the washing liquor may have between 0.5 g and 10 g of the composition per litre of washing liquor, preferably between 1 g and 5 g, even more preferably between 3 g and 5 g. If the composition is added to a bucket with water, the washing liquor may have between 0.5 g and 20 g of the composition per litre of washing liquor, preferably between 1 g and 15 g, more preferably between 5 g and 15 g.

When the composition is added to a bucket with water, soaking is performed for a predetermined length of time, which may be between 30 minutes and 2 hours, preferably between 45 minutes and 90 minutes, more preferably for about one hour.

It should be noted that the temperature of the washing liquor may be between 10° C. and 60° C., preferably between 10° C. and 45° C. The present inventors have observed that the composition according to the first aspect of the invention removes stains, in particular greasy or oil-based stain, and malodour even at lower temperatures than those usually used in washing operation, for example at 25° C. or even at 15° C.

This means that the method according to the second or third aspect allows for the removal of greasy or oil-based stains and malodour, and preferably whiteness improvement, even at temperatures of for example 25° C. or 20° C. or 15° C. If the washing temperature is reduced, then energy consumption is also reduced.

In a fourth aspect, the invention relates to a use of the composition according to the first aspect in a laundry washing and/or fabric treatment operation.

In a fifth aspect, the invention relates to a use of the composition according to the first aspect for the removal of greasy or oil-based stains, and/or the removal of malodour from a garment.

In a preferred embodiment of the fifth aspect, said garment is made of cotton, synthetic materials or a combination thereof, preferably wherein said synthetic material is polyester.

The foregoing aspects may be freely combined with any of the foregoing aspects disclosed herein.

All percentages used in this disclosure are by weight unless otherwise specified.

The present invention will now be described in relation to the following non-limiting Examples.

### EXAMPLES

### Formulations

Formulations A and B in Table 1 are comparative compositions not according to the invention, whilst formulation 1 is a formulation according to the invention.

TABLE 1
Formulations

| | Formulation | | |
|---|---|---|---|
| Ingredient | A | B | 1 |
| Sodium Carbonate | 42.65 | 43.55 | 52.05 |
| Sodium Sulphate | 16.40 | 16.40 | 16.40 |
| Sodium Percarbonate | 38.00 | 37.00 | 29.00 |
| TAED (free) | 0.50 | 0.50 | 0.50 |
| Oxygen transfer agent | | | 0.10 |
| Surfactants | 1.8 | 1.8 | 1.20 |
| Protease/Cellulase | 0.30 | 0.30 | 0.30 |
| Lipase | | 0.1 | 0.1 |
| Amylase | 0.10 | 0.10 | 0.10 |
| Dye transfer inhibitor | 0.25 | 0.25 | 0.25 |

Oxygen transfer agent = 3-methyl-1,2-benzisothiazol-1,1-dioxide.
The amounts of enzymes in table 2 are the amounts of these as received from a supplier.
The protease/cellulase refers to a blend of protease-cellulase.

### Performance Tests

### Removal of Stains in Washing Machine

Technical stains supported on cotton were washed in a laundry washing machine in a washing liquor containing one of the detergent systems shown in Table 2 at about 25° C.

TABLE 2
Detergent systems

| Detergent system | Components |
|---|---|
| Da | 80 g Commercial detergent + 60 g of Formulation A |
| Db | 80 g Commercial detergent + 60 g of Formulation B |
| D1 | 80 g Commercial detergent + 60 g of Formulation 1 |

The commercial detergent in Table 2 is OMO 10X as sold in the Brasil.

### Washing Test Conditions

Technical stained fabrics were washed using one of the detergent systems of Table 2. Each sample was washed in BRASTEMP BWJ09ABBNA30 laundry washing machine at a temperature of about 25° C. using a Dia a Dia-Medium cycle (time of main wash about 67 minutes), water hardness of 12° F.

Stain removal was determined using a Datacolor 650 spectrophotometer and by measuring the Y-value of the technical stain after washing. In table 3:
stain removal performance of the detergent system comprising Formulation 1 (D1) is compared with the stain removal performance of the detergent system comprising Formulation A (Da)
stain removal performance of the detergent system comprising Formulation 1 (D1) is compared with the stain removal performance of the detergent system comprising Formulation B (Db).

In table 3, “0” means no difference regarding stain removal performance, compared to the detergent system comprising Formulation A or Formulation B, and “+” means improved stain removal performance.

TABLE 3
Stain removal of technical stains supported on cotton at about 25° C.

| | | | Stain | Stain |
|---|---|---|---|---|
| | | | removal | removal |
| | | | performance | performance |
| | | | of Detergent | of Detergent |
| | | | system D1 | system D1 |
| | | | compared to | compared to |
| | | | Detergent | Detergent |
| | Code Stain | Technical Stain | system Da | system Db |
| Bleachable | C-S-15 | Blueberry juice | 0 | |
| stains | WE5ECWKC | Coffee | + | |
| | WE5RWWKC | Red wine | 0 | |
| | W-10SG | Spaghetti sauce with meat | 0 | |
| | W-10U | Curry | + | |
| | WE5FSMWKC | French Squeeze Mustard | 0 | |
| | WE5GMWKC | Grass/Mud | 0 | |
| | WE5SGWKC | Grass scrubbed | 0 | |
| Enzyma | C-S-406 | Balsamic Dressing | 0 | |
| | W-10Z | Chocolate | 0 | |
| Greasy | KC-H015 | Frying fat | + | 0 |
| stains | W-10RM | Soot mineral oil | + | 0 |
| | W-10V | Soy sauce | + | + |
| | WE5BBWKC | Cooked beef fat | 0 | + |

(Each value in table 3 is the average of four measurements)

The results in table 3 demonstrate that the formulation according to the invention provides better removal of greasy stains than the comparative formulations. This effect is achieved with a lower amount of bleaching agent.

In addition, the present inventors have observed that the formulation according to the invention provides excellent malodour removal.

The composition according to the invention provides:
removal of greasy or oil-based stains;
malodour removal; and
preferably also whiteness improvement in a garment.

Hence one or more objects of the present invention are achieved by the present which is further elucidated in the appended claims.

1.-15. (canceled)

16. A composition comprising:
between 22 wt. % and 30 wt. % of at least one bleaching agent, based on the total weight of the composition,
between 0.001 wt. % and 2 wt. % of at least one oxygen transfer agent, based on the total weight of the composition, wherein said at last one oxygen transfer agent is selected from the group comprising 3-methyl-1,2-benzisothiazol-1,1-dioxide, 1,2,3-Benzoxathiazine, 2,2-dioxide, and combinations thereof,
at least one bleach activator, and
between 0.001 wt. % and 1 wt. % of at least one lipase, based on the total weight of the composition.

17. The composition according to claim 16, wherein said composition comprises:
between 25 wt. % and 30 wt. % of said at least one bleaching agent, based on the total weight of the composition, and
between 0.005 wt. % and 1.5 wt. % of said at least one oxygen transfer agent, based on the total weight of the composition.

18. The composition according to claim 16, wherein said at least one bleaching agent comprises at least one source of active oxygen selected from the group comprising an inorganic peroxide, an organic peracid, and combinations thereof.

19. The composition according to claim 18, wherein said at least one bleaching agent is selected from the group comprising hydrogen peroxide, sodium percarbonate, ε-phthalimido-peroxy-hexanoic acid (PAP), peracetic acid, potassium peroxymonosulfate (KMPS), and combinations thereof.

20. The composition according to claim 19, wherein said at least one bleaching agent comprises or consist of sodium percarbonate.

21. The composition according to claim 16, wherein said composition comprises between 0.1 wt. % and 20 wt. % of said at least one bleach activator, based on the total weight of the composition.

22. The composition according to claim 16, wherein said at least one bleach activator is selected from the group consisting of tetraacetylethylendiamine (TAED), acetylated triazine derivatives, acetylated glycoluriles, acylimides, acetylated phenolsulfonates, acetylated phenol carbonic acids, carbonic acid anhydrides, acetylated sugar derivatives, N-acetylated lactams, and combinations thereof.

23. The composition according to claim 22, wherein said at least one bleach activator comprises or consists of tetraacetylethylendiamine (TAED).

24. The composition according to claim 16, wherein said at least one oxygen transfer agent comprises or consists of 3-methyl-1,2-benzisothiazol-1,1-dioxide.

25. The composition according to claim 16, wherein said composition further comprises between 0.0001 wt. % and 10 wt. % of one or more further enzymes, based on the total weight of the composition wherein said one or more further enzymes are selected from the group consisting of a mannanase, an amylase, a cellulase, a protease, and combinations thereof.

26. The composition according to claim 16, wherein said composition is a laundry detergent composition or a laundry additive composition.

27. The composition according to claim 16, wherein the pH at 20° C. of a dilution of 1:100 of the composition is between 9 and 12.

28. The composition according to claim 16, wherein the composition is in form of a solid or a powder.

29. A method of laundering a fabric in a laundry washing machine comprising adding the composition according to claim 16 to the washing machine and conducting the wash.

30. The method of laundering a fabric in a laundry washing machine of claim 29, wherein the wash liquor is at a temperature higher than 15° C. and lower than 40° and wherein preferably between 0.5 g and 10 g of the composition are added to the laundry washing machine per litre of washing liquor.

31. A method of cleaning a stain on a laundry item comprising:
mixing the composition according claim 16 with water and contacting the stain directly with the obtained mixture before the laundry item is washed, or
adding the composition according to claim 1 directly into the drum of washing machine, or
adding the composition according to claim 1 to a bucket with water and soaking for a predetermined length of time.

32. A laundry washing and/or fabric treatment operation comprising the use of the composition of claim 16.

33. A method of removing of greasy or oil-based stains and/or the removal of malodour from a garment comprising the use of the composition of claim 16.

34. The method of claim 33, wherein said garment is made of cotton, synthetic materials or a combination thereof.
